(19) United States
(12) Patent Application Publication
(10) Pub. No.: US 2018/0202316 A1
(43) Pub. Date: Jul. 19, 2018

(54) BORESCOPE VACUUM RETRIEVAL SYSTEM

(71) Applicant: General Electric Company, Schenectady, NY (US)

(72) Inventors: Cezar Negoescu, Popesti-Leordeni (RO); Marius Dinu, Popesti Leodeni (RO); Nicholas Aleksander Miasnikov, Schenectady, NY (US); Kelles Jay Fleming, Barnesville, GA (US)

(21) Appl. No.: 15/867,884

(22) Filed: Jan. 11, 2018

(30) Foreign Application Priority Data
Jan. 19, 2017 (RO) A201700031

(51) Int. Cl. F01D 25/00; F04F 5/20; F04F 5/46; A47L 5/18; A47L 9/28; A47L 9/24; B08B 9/035; B08B 9/08

(52) U.S. Cl. CPC F01D 25/002; F04F 5/20; F04F 5/463; A47L 5/18; G02B 23/2476; A47L 9/2857; A47L 9/242; B08B 9/035; B08B 9/08; A47L 9/2805

(57) ABSTRACT

The present application provides a borescope vacuum retrieval system for foreign objects. The borescope vacuum retrieval system may include a compressed air driven ejector vacuum system and a borescope in communication with the compressed air driven ejector vacuum system.

### TECHNICAL FIELD

The present application and resultant patent relate generally to inspection systems and methods and more particularly relate to a borescope vacuum retrieval system using one or more compressed air driven ejectors to provide a powerful but maneuverable vacuum retrieval and inspection system.

### BACKGROUND OF THE INVENTION

Heavy duty industrial equipment such as gas turbine engines and the like must be inspected regularly so as to ensure efficient and reliable operation. Gas turbine components are often visually inspected using a borescope or a similar device. A borescope may be an elongated flexible tube with a camera head assembly. The borescope provides for internal inspection without disassembly of the component. Finding a foreign object within a component of, for example, a gas turbine engine, presents further problems. Not only must the foreign object be removed and/or the component replaced, but the foreign object generally must be recovered for further investigation as to its provenience. Such recovery efforts may be difficult and time consuming.

### SUMMARY OF THE INVENTION

The present application and the resultant patent provide a borescope vacuum retrieval system for foreign objects. The borescope vacuum retrieval system may include a compressed air driven vacuum system and a borescope in communication with the compressed air driven ejector vacuum system.

The present application and the resultant patent further provide a method of inspecting an enclosed space for a foreign object. The method may include the steps of positioning a borescope about a compressed-air-driven ejector vacuum system, maneuvering a borescope probe of the borescope together with a suction hose of the compressed-air-driven ejector vacuum system within the enclosed space, observing the foreign object in the enclosed space with the borescope probe, and removing the foreign object with the suction hose of the compressed-air-driven ejector vacuum system.

The present application and the resultant patent further provide a borescope vacuum retrieval system for foreign object. The borescope vacuum retrieval system may include a compressed air driven ejector vacuum system with one or more ejectors in communication with a suction hose and a borescope mounted with the suction hose of the compressed air driven ejector vacuum system.

These and other features and improvements of the present application and the resultant patent will become apparent to one skilled in the art upon the review of the following detailed description and taken in conjunction with the several drawings and the appended claims.

### BRIEF DESCRIPTION OF THE DRAWINGS

FIG. 1 is a simplified perspective view of a borescope vacuum retrieval system as may be described herein.

FIG. 2 is a further simplified perspective view of the borescope vacuum retrieval system of FIG. 1.

FIG. 3 is a partial sectional top view of the borescope vacuum retrieval system of FIG. 1 showing the ejector assembly.

FIG. 4 is a further partial sectional side view of the borescope vacuum retrieval system of FIG. 1.

FIG. 5 is a partial plan view of a head end of the borescope vacuum retrieval system of FIG. 1.

FIG. 6 is a partial plan view of an alternative embodiment of a head end of the borescope vacuum retrieval system as may be described herein.

FIG. 7 is a partial sectional view of an alternative embodiment showing the borescope insertion tube inserted into the vacuum hose of the borescope vacuum retrieval system as may be described herein.

### DETAILED DESCRIPTION

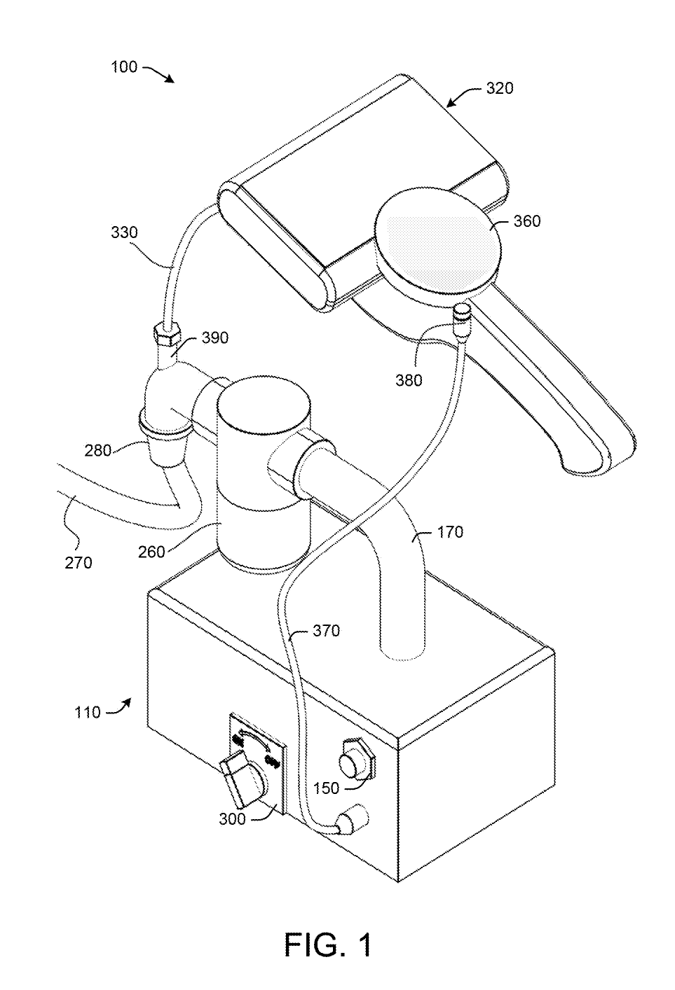

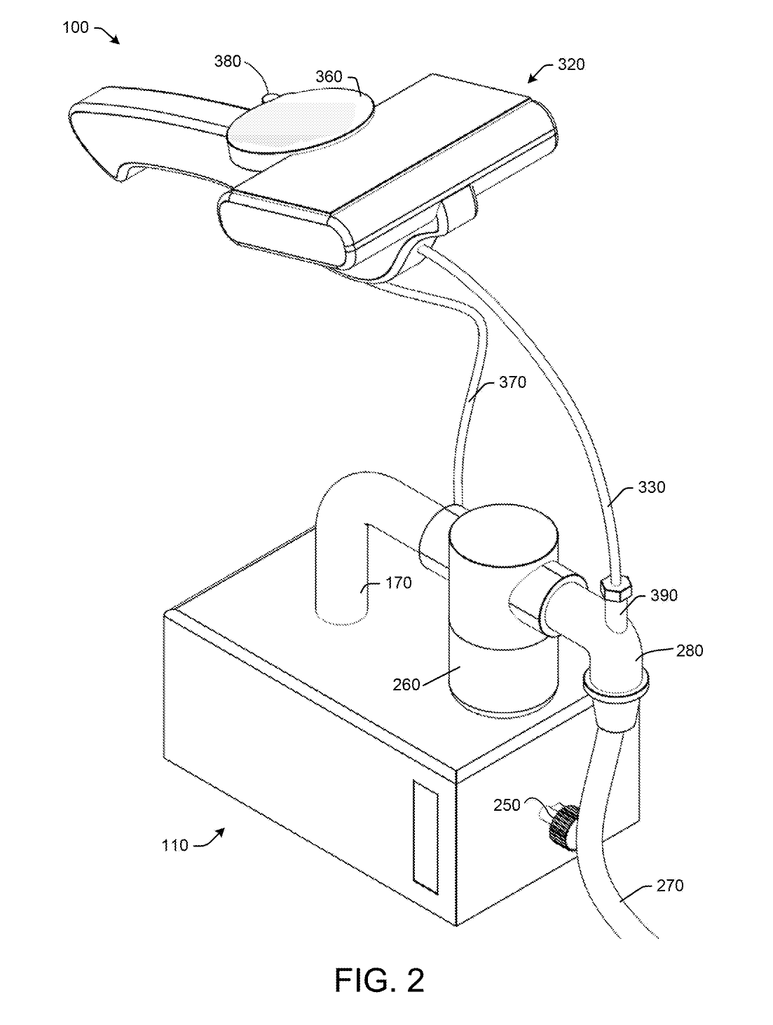

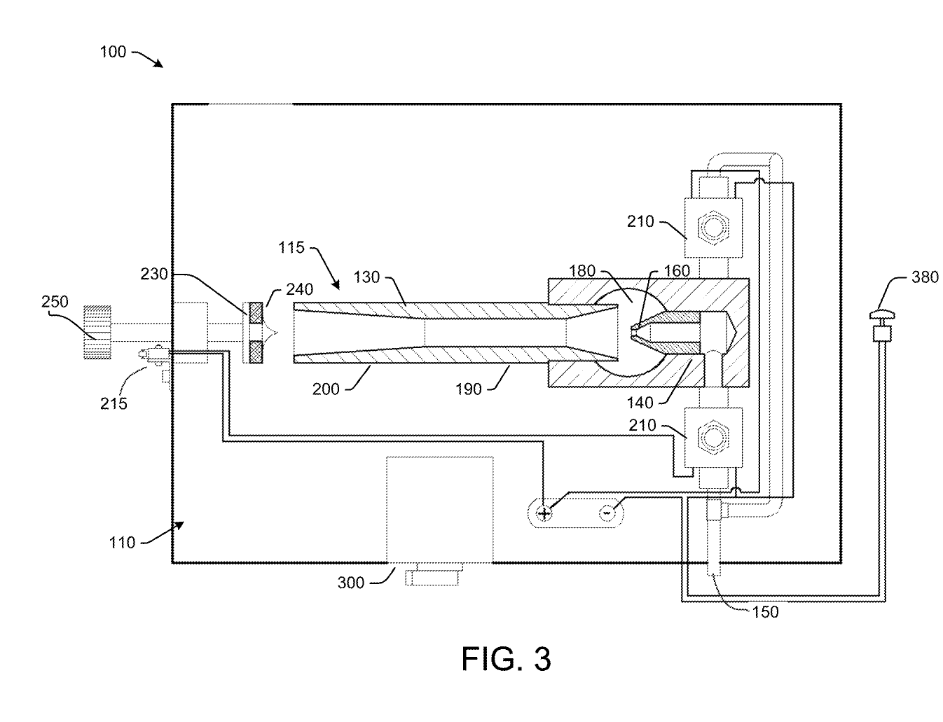

Referring now to the drawings, in which like numerals reflect like components throughout the several views, FIG. 1-5 show an example of a borescope vacuum retrieval system 100 as may be described herein. As described above, the borescope vacuum retrieval system 100 may be used for detecting and removing foreign objects and debris from an enclosed industrial region such as a gas turbine engine and the like. The borescope vacuum retrieval system 100 may have any number of different applications.

The borescope vacuum retrieval system 100 may include an ejector vacuum system 110. The ejector vacuum system 110 may include a pair of ejectors 115. In this example, a main ejector 120 and a boost ejector 130 may be used. An ejector is a mechanical device with no moving parts. The ejector mixes two fluid streams based on a momentum transfer. Each ejector 115 may include a motive air inlet 140. The motive air inlet 140 may be communication with a source of compressed air through a connector 150. The motive air inlet 140 leads to a motive nozzle 160. The ejectors 120, 130 also may include a suction air inlet 170. The suction air inlet 170 may lead to a suction chamber 180. The motive nozzle 160 and the suction chamber 180 may lead to a mixing tube 190 and a diffuser 200. The ejectors 115 may have any suitable size, shape, or configuration. Other components and configurations may be used herein.

The motive air inlets 140 may be controlled via a solenoid valve 210. The solenoid valve 210 may be battery operated and/or use other types of conventional power sources. The solenoid valve 210 for the boost ejector 130 may have a snap switch 215 thereon. The downstream end of the main ejector 120 may have a main deflector 220 positioned thereon. Likewise, the boost ejector 130 may have a boost deflector 230 positioned thereon. The boost deflector 230 may include a rubber gasket 240. The boost deflector 230 may be maneuverable via turning a boost handle 250. Turning the boost handle 250 may position the rubber gasket 240 of the boost deflector 230 within the boost ejector 130 so as to activate the snap switch 215 and interrupt the electrical circuit for the boost ejector solenoid valve 210. The boost handle may be moving until the rubber gasket 240 closes the exit of the diffuser 200. In this way, the main ejector 120 can run singly without losing the vacuum through the boost ejector 130. Other components in the configurations may be used herein.

The suction air inlet 170 of the ejectors 120, 130 may be in communication with a suction chamber 260. The suction chamber 260 may be made out of a translucent material and the like such that objects therein may be visible therein. The suction chamber 260 may have any suitable size, shape, or configuration. The suction chamber 260 may be in communication with a suction hose 270. The suction hose 270 may be made out of any type of conventional flexible tubing. The suction hose 270 may have any suitable size, shape or configuration. The suction hose 270 may be in communication with the suction chamber 260 via an elbow connector 280 and the like. Other types of connection means may be used herein. Different types and/or sizes of suction hoses 270 may be attached to the elbow connector 280 via one or more adaptors 290 and the like. Other components and other configurations may be used herein.

The ejectors 120, 130 may be positioned about a magnetic base 300, with a strong round permanent magnet. The magnetic base 300 may be similar to that used in metalworking or optics to hold a dial indicator. The magnetic base 300 may have any suitable size, shape, or configuration. The base may be magnetized through the round permanent magnet that can be rotated through a handle attached at the magnet, such that the poles are into two iron halves and the iron blocks act as keepers. The magnetic base 300 serves to secure the overall borescope inspection and removal system 100 in place as desired.

The borescope inspection and removal system 100 also may include a borescope 320. The borescope 320 may be of conventional design. The borescope 320 may include a flexible borescope probe 330. The borescope probe 330 may include a conventional camera or other type of inspection device. Different types of borescope probes 330 may be used herein. The borescope 320 may be in communication with the ejector vacuum system 110 and the solenoid valves 210 via a control line 370 and a control switch 380. The control switch 380 may be located near a borescope control panel 360 such that the control switch can be acted by the inspector with the same hand used for borescope control panel 360. Other components and other configurations may be used herein.

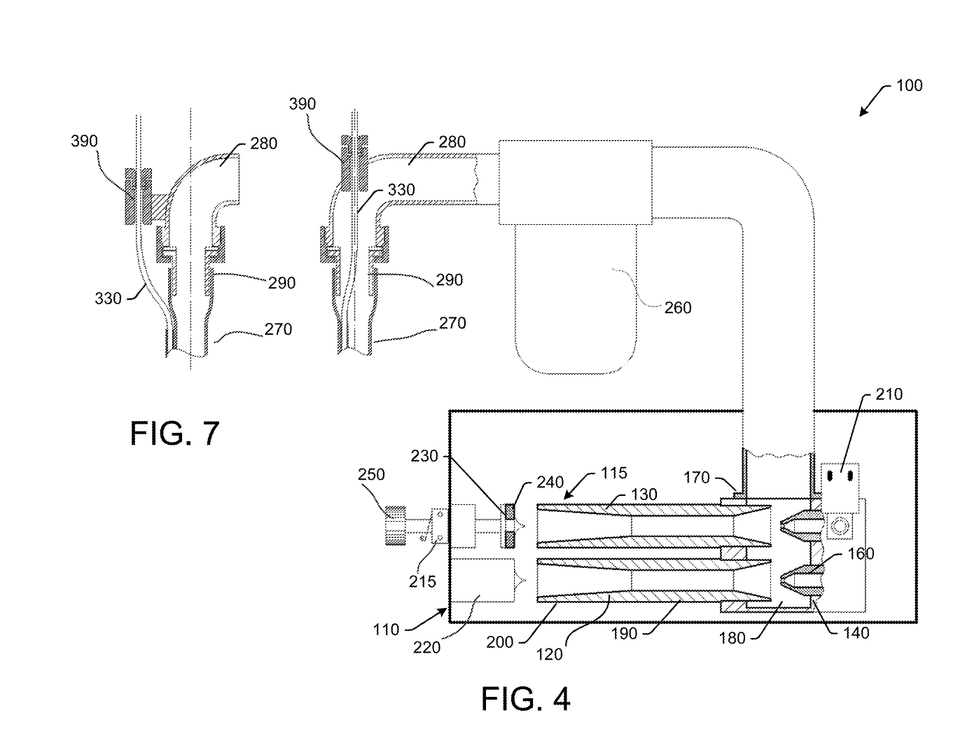

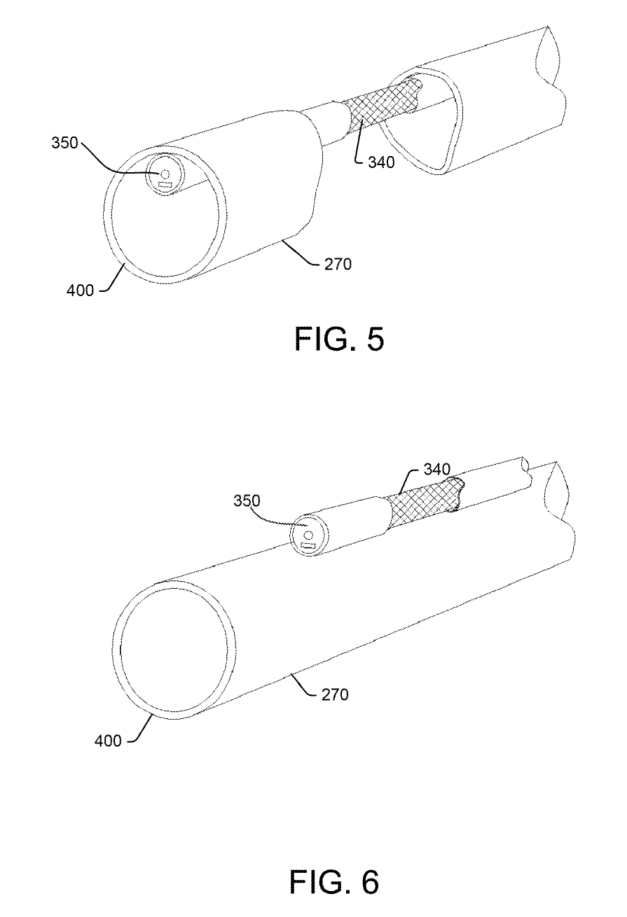

The borescope probe 330 of the borescope 320 may be positioned about the suction hose 270 of the ejector vacuum system 110. The borescope probe 330 insertion tube may extend either into or adjacent to the suction hose 270 through a hose welded side by side with the vacuum hose. For example, FIGS. 4 and 5 show the borescope probe 330 and a borescope line 350 within the suction hose 270. A borescope probe 330 insertion tube may be attached inside the vacuum hose 270 in the desired position via a gland nut 390 and the like. The borescope probe 330 thus may be attached at a head end 400 of the suction hose 270 at a head end tube 400. Alternatively as is shown in FIG. 6, the borescope probe 330 may be slightly removed from the head end 400 of the suction hose 270 so as to avoid the assertion of the borescope probe camera head into debris and/or liquids. Further, as is shown in FIGS. 6 and 7, the borescope probe 330 insertion tube may be positioned outside of the suction hose 270. In these examples, the borescope probe 330 also may be positioned outside the head end 400 of the suction hose 270. Other components and configurations may be used herein.

In use, the borescope vacuum retrieval system 100 may be used to detect and remove foreign objects within any enclosed space. The suction hose 270 of the ejector vacuum system 110 with the borescope 320 may be maneuvered as desired due the great flexibility of the suction hose 270 end that is moved by a bending neck 340. The bending neck 340 may be the articulating section of the insertion tube borescope probe 330, and can be moved left and right, up and down by the inspector through the joystick from the borescope control panel 360. The operation of the ejector vacuum system 110 may be controlled via the control switch 380 that operates either or both of the main ejector 120 and the boost ejector 130. Any foreign object pulled into the suction hose 270 may be caught and inspected within the suction chamber 260. The additional use of the boost ejector 130 provides a stronger suction force as necessary. The borescope vacuum retrieval system 100 thus may be easily maneuvered.

Other than batteries for the solenoid valves 210, no electrical system may be needed. Rather, the ejector vacuum system 110 simply runs on compressed air. Further, because the ejector vacuum system 110 has no moving parts, the vacuum system 110 is largely maintenance free with no accidental contamination risk with respect to debris and the like. The vacuum hose 270 end can be easy moved in every position by the moving of the bending neck 340 of the borescope probe 330. The main ejector 120 may operate singly or together with the boost ejector 130 without the use a one-way flap vacuum valve due the capability of the boost ejector 130 to be isolated. The use of a one-way flap vacuum valve would increase the size of the ejector assembly and also could present problems if the flap is accidentally blocked in the opened position. The magnetic base 300 allows the overall borescope vacuum retrieval system 100 to be secured as necessary. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalence thereof.

We claim:

1. A borescope vacuum retrieval system for foreign objects, comprising:
a compressed air driven ejector vacuum system; and
a borescope cooperating with the compressed air driven ejector vacuum system.

2. The borescope vacuum retrieval system of claim 1, wherein the compressed air riven ejector vacuum system comprises a main ejector.

3. The borescope vacuum retrieval system of claim 2, wherein the main ejector comprises a motive air inlet and a suction air inlet.

4. The borescope vacuum retrieval system of claim 3, wherein the main ejector comprises a motive nozzle in communication with the motive air inlet and a suction chamber in communication with the suction air inlet.

5. The borescope vacuum retrieval system of claim 4, wherein the main ejector comprises a mixing tube and a diffuser.

6. The borescope vacuum retrieval system of claim 2, wherein the main ejector comprises a main deflector thereon.

7. The borescope vacuum retrieval system of claim 2, wherein the compressed air driven ejector vacuum system comprises a boost ejector.

8. The borescope vacuum retrieval system of claim 7, wherein the boost ejector comprises a boost deflector.

9. The borescope vacuum retrieval system of claim 8, wherein the boost deflector comprises a gasket in communication with a boost handle.

10. The borescope vacuum retrieval system of claim 9, wherein the boost handle comprises a snap switch to control a solenoid valve.

11. The borescope vacuum retrieval system of claim 1, wherein the compressed air driven ejector vacuum system comprises a translucent suction chamber.

12. The borescope vacuum retrieval system of claim 1, wherein the compressed air driven ejector vacuum system comprises a suction hose and wherein the borescope comprises a borescope line positioned about the suction hose.

13. The borescope vacuum retrieval system of claim 12, wherein the borescope comprises a borescope probe positioned within a head end of the suction hose.

14. The borescope vacuum retrieval system of claim 12, wherein the borescope comprises a borescope probe positioned adjacent to a head end of the suction hose.

15. A method of inspecting an enclosed space for a foreign object, comprising:
positioning a borescope about an ejector vacuum system;
maneuvering a borescope probe of the borescope together with a suction hose of the ejector vacuum system within the enclosed space;
observing the foreign object in the enclosed space with the borescope probe; and
removing the foreign object with the suction hose of the ejector vacuum system.

16. A borescope vacuum retrieval system for foreign objects, comprising:
a compressed air driven ejector vacuum system with one or more ejectors in communication with a suction hose; and
a borescope mounted with the suction hose of the compressed air driven ejector vacuum system.

17. The borescope vacuum retrieval system of claim 16, wherein the compressed air driven ejector vacuum system comprises a main ejector and a boost ejector.

18. The borescope vacuum retrieval system of claim 16, wherein the compressed air driven ejector vacuum system comprises a compressed air source.

19. The borescope vacuum retrieval system of claim 16, wherein the compressed air driven ejector vacuum system comprises a translucent suction chamber.

20. The borescope vacuum retrieval system of claim 16, wherein the borescope comprises a borescope probe positioned about a head end of the suction hose.
